(19) United States
(12) Patent Application Publication
(10) Pub. No.: US 2019/0007903 A1
(43) Pub. Date: Jan. 3, 2019

(54) COORDINATED NEIGHBOR AWARE NETWORK (NAN) ROLE ASSIGNMENT

(71) Applicant: QUALCOMM Incorporated, San Diego, CA (US)

(72) Inventors: Sumanth KERAGODU SURYA PRAKASH, San Jose, CA (US); Alireza RAISSINIA, Monte Sereno, CA (US); Ravi GIDVANI, Fremont, CA (US)

(21) Appl. No.: 15/984,214

(22) Filed: May 18, 2018

Related U.S. Application Data
(60) Provisional application No. 62/526,167, filed on Jun. 28, 2017.

(51) Int. Cl. H04W 52/02

(52) U.S. Cl. CPC H04W 52/0235; H04W 88/02

(57) ABSTRACT

This disclosure provides systems, methods and apparatus, including computer programs encoded on computer storage media, for wireless communication in a neighbor aware network (NAN). In one aspect, a first device of a wireless network (such as a NAN), in response to detecting a low power condition, may transmit a beacon including a power indicator. Other devices of the NAN may process the beacon and determine whether to assume a role of master or non-master sync in the NAN based on the power indicator. For example, a second device of the NAN may determine, based on power information of the second device, to assume the role of master or non-master sync in the NAN. To assume the role of master (or non-master sync), the second device may transmit a second beacon that includes a modified rank value.

### I. CROSS REFERENCE TO RELATED APPLICATIONS

The present application claims priority from U.S. Provisional Patent Application No. 62/526,167 entitled “COORDINATED NEIGHBOR AWARE NETWORK (NAN) ROLE ASSIGNMENT,” filed Jun. 28, 2017, which is incorporated herein by reference in its entirety.

### II. TECHNICAL FIELD

The present disclosure is generally related to role assignment in a neighbor aware network (NAN).

### III. DESCRIPTION OF RELATED ART

Advances in technology have resulted in smaller and more powerful computing devices. For example, a variety of portable personal computing devices, including wireless computing devices, such as portable wireless telephones, personal digital assistants (PDAs), and paging devices are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone also can include a digital still camera, a digital video camera, a digital recorder, and an audio file player. Also, wireless telephones can process executable instructions, including software applications, such as a web browser application, that can be used to access the Internet. As such, these wireless telephones can include significant computing capabilities.

Devices, such as wireless telephones, may use wireless connections to access networks in order to transmit and receive data or to exchange information. For example, the devices may use a neighbor aware network (NAN) or a wireless mesh network to perform data exchanges via the NAN (such as without involving wireless carriers, Wi-Fi access points, or the Internet). Each device within the NAN may assume a role of master (such as operate in a NAN master device operating mode) or in a non-master role (such as operate in a NAN non-master device operating mode).

Additionally, devices in the role of non-master can have a synchronization (sync) state (such as non-master sync) or a non-sync state (such as non-master non-sync). Devices in the role of master transmit discovery beacons so that devices not included in the NAN can identify and join the NAN. Additionally, devices in the roles of master and non-master sync transmit synchronization beacons (such as timing information) to enable coordination of devices within the NAN. Transmission of synchronization beacons can cause devices in the roles of master and non-master sync to consume power (such as experience a power penalty). Additionally, transmission of discovery beacons can cause devices in the role of master to consume power (such as experience a power penalty).

### IV. SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication includes receiving, from a first device at a second device of a neighbor aware network (NAN), a first beacon including a power indicator associated with the first device. The method also includes, based on the power indicator, transmitting a second beacon from the second device to one or more devices of the NAN. The one or more devices include the first device. The second beacon indicates a modified rank value associated with a master rank of the second device.

In some implementations, the modified rank value indicates a role transition of the second device. In some implementations, the first beacon includes a synchronization beacon or a discovery beacon and, during transmission of the first beacon, the first device has a master role in the NAN and the second device has a non-master role in the NAN.

In some implementations, the power indicator includes an attribute identifier of a vendor specific attribute (VSA). The first beacon may further include a vendor identifier included in a vendor identifier portion of the VSA, and each of the first device and the second device may be associated with the vendor identifier.

In some implementations, the first beacon further includes power information corresponding to the first device. The power information may be included in a body portion of a vendor specific attribute. Additionally, or alternatively, the power information may indicate an amount of available power at the first device, an estimated duration of remaining power at the first device, a power consumption rate of the first device, or a combination thereof.

In some implementations, the method further includes identifying the power indicator included in the first beacon and, in response to identifying the power indicator included in the first beacon, determining whether to transmit the second beacon.

In some other implementations, the method includes identifying the power indicator included in the first beacon and, in response to identifying the power indicator included in the first beacon: determining, at the second device, power information associated with a power supply of the second device and comparing the power information to a threshold. The method may further include, in response to determining that the power information satisfies the threshold, modifying the rank value of the second device. The method may further include, in response to determining that the power information satisfies the threshold, modifying a master preference value of the second device, a random factor of the second device, an interface address of the second device, or a combination thereof. The second beacon may include the modified master preference value, the modified random factor, the modified interface address, or a combination thereof. Additionally, or alternatively, the method may further include, in response to determining that the power information satisfies the threshold, adjusting a transmit power of the second device. The transmit power may be adjusted to be greater than or equal to a received signal strength associated with one or more beacons received from the first device.

In some other implementations, the method further includes determining, at the second device, power information associated with a power supply of the second device and transmitting, from the second device to a third device, a third beacon that includes a second power indicator associated with the power information. During transmission of the third beacon, the second device may have a master role in the NAN and the third device has a non-master role in the NAN. The method may further include comparing the power information to a threshold and, in response to determining that the power information satisfies the threshold, generating the third beacon that includes the second power indicator. Additionally, or alternatively, the method may further include receiving, from the third device after transmitting the third beacon, a fourth beacon that indicates a rank value of the third device and, based on the rank value of the third device, modifying a role indicator of the second device to correspond to a non-master role.

Another innovative aspect of the subject matter described in this disclosure can be implemented in an apparatus includes a receiver configured to receive a first beacon that includes a power indicator from a first device of a neighbor aware network (NAN) at a second device of the NAN. The apparatus also includes a transmitter configured to transmit a second beacon based on the power indicator to one or more devices of the NAN. The one or more devices include the first device. The second beacon indicates a modified rank value associated with a master rank of the second device.

In some implementations, the power indicator includes a vendor specific information element. Additionally, or alternatively, the first beacon includes a discovery beacon or a synchronization beacon. Additionally, or alternatively, the receiver and the transmitter are integrated into a mobile communication device.

In some implementations, the apparatus also includes a processor configured to determine power information associated with a power supply. The transmitter may be configured to transmit a third beacon that includes a second power indicator associated with the power information to at least one device of the NAN. In some implementations, the second power indicator is associated with a low power condition and corresponds to a request for another device of the NAN to assume a master role of the NAN. In some implementations, the third beacon further includes the power information, and a format of the second power indicator and the power information is based on a vendor specific attribute (VSA). In some implementations, the apparatus further includes a battery. The processor may be further configured to determine the power information associated with the battery. The power information may include a power level of the battery, a power consumption rate associated with the battery, an estimated duration of power remaining in the battery, or a combination thereof.

Another innovative aspect of the subject matter described in this disclosure can be implemented in an apparatus includes means for receiving, from a first device at a second device of a neighbor aware network (NAN), a first beacon including a power indicator associated with the first device. The apparatus also includes means for transmitting, based the power indicator, a second beacon to one or more devices of the NAN. The one or more devices include the first device. The second beacon indicates a modified rank value to the device. In some implementations, the means for receiving and the means for transmitting are incorporated into a mobile communication device.

Another innovative aspect of the subject matter described in this disclosure can be implemented in a computer-readable storage device that stores instructions, when executed by a processor, cause the processor to perform operations including generating a second beacon at a second device based on a power indicator included in a beacon received from a first device of a neighbor aware network (NAN). The power indicator is associated with the first device. The second beacon indicates a modified rank value associated with a master rank of the second device. The operations further include initiating transmission of the second beacon to one or more devices of the NAN. The one or more devices include the first device.

Another innovative aspect of the subject matter described in this disclosure can be implemented in a method includes determining, at a first device of a neighbor aware network (NAN), power information associated with a power supply of the first device. The method further includes transmitting, from the first device to a second device of the NAN, a beacon that includes a power indicator associated with the power information.

Another innovative aspect of the subject matter described in this disclosure can be implemented in an apparatus includes a processor configured to determine power information associated with a power supply. The apparatus further includes a transmitter configured to transmit a beacon that includes a power indicator associated with the power information to at least one device of a neighbor aware network (NAN).

Another innovative aspect of the subject matter described in this disclosure can be implemented in an apparatus includes means for determining, at a first device of a neighbor aware network (NAN), power information associated with a power supply of the first device. The apparatus further includes means for transmitting, from the first device to a second device of the NAN, a beacon that includes a power indicator associated with the power information.

Another innovative aspect of the subject matter described in this disclosure can be implemented in a computer-readable storage device that stores instructions, when executed by a processor, cause the processor to perform operations including determining, at a first device of a neighbor aware network (NAN), power information associated with a power supply of the first device. The operations further include initiating transmission, from the first device to a second device of the NAN, a beacon that includes a power indicator associated with the power information.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### V. BRIEF DESCRIPTION OF THE DRAWINGS

FIG. 1 shows an example diagram of a system that includes at least one device configured to transmit a beacon that includes a power indicator.

FIG. 2 is a ladder diagram corresponding to operation of a particular aspect of the system of FIG. 1

FIG. 3 is a flow diagram of a first illustrative method of operation at a device of a NAN;

FIG. 4 is a flow diagram of a second illustrative method of operation at a device of a NAN;

FIG. 5 is a flow diagram of a third illustrative method of operation at a device of a NAN; and

FIG. 6 is a diagram of a wireless device that is operable to support various implementations of one or more methods, systems, apparatuses, and computer-readable media disclosed herein.

Like reference numbers and designations in the various drawings indicate like elements.

### VI. DETAILED DESCRIPTION

As used herein, an ordinal term (such as “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term).

As used herein, various terminology is for the purpose of describing particular implementations only and is not intended to be limiting of implementations. For example, the singular forms “a,” “an,” and “the” are intended to include the plural forms as well, unless the context clearly indicates otherwise. It may be further understood that the terms “comprises” and “comprising” may be used interchangeably with “includes” or “including.” Additionally, it will be understood that the term “wherein” may be used interchangeably with “where.”

In the present disclosure, a device having a role of master or non-master in a wireless network, such as a neighbor aware network (NAN) or a wireless mesh network, may transmit or receive a beacon, such as a discovery beacon or a synchronization beacon, that includes a power indicator. The power indicator may be associated with or correspond to a request for another device of the NAN to assume a role of master (or non-master sync). The power indicator may be a single bit (having a value of one or zero) or multiple bits (having a particular value). In some implementations, the power indicator is associated with a vendor specific information element (i.e., a vendor specific attribute (VSA)), as described further herein.

To illustrate, a first device (such as a master device or a non-master sync device) of the NAN that is configured to transmit a beacon may detect a low power condition associated with a power supply, such as a battery, of the first device. For example, the first device may determine power information (such as a power level of the power supply, a power consumption rate associated with the power supply, an estimated duration of power remaining in the power supply, or a combination thereof) associated with the first device. The first device may compare the power information to one or more thresholds, and the first device may detect the low power condition if the power information satisfies the one or more thresholds. For example, the low power condition may be detected if the power level of the power supply is less than or equal to a first threshold, the power consumption rate is greater than or equal to a second threshold, the estimated duration of the power remaining is less than or equal to a third threshold, or a combination thereof.

Based on detection of the lower power condition, the first device transmits a beacon, such as a discovery beacon or a synchronization beacon, that includes a power indicator. To illustrate, in a particular implementation, the first device generates a power indicator, includes (such as inserts) the power indicator in a beacon, and transmits the beacon. For example, the first device may indicate the beacon at a next beacon transmit time, such as during a next discovery window. The power indicator may be associated with a VSA (such as a vendor specific information element) that is included in the beacon. The VSA may have a format that includes one or more fields, such as an attribute identifier field, a length field, a vendor specific organizationally unique identifier (OUI) field, and a body field. The power indicator may be included in the attribute identifier field. A value of the length field may indicate a length of the OUI field, the body field, or a combination thereof. A value of the vendor specific OUI field may be used to identify devices (such as the first device) manufactured by the same vendor, distributed by the same vendor, or operated according to software provided by the same vendor. Devices that have the same particular vendor may be configured to process vendor specific attributes having the vendor specific OUI of the particular vendor. The body field may include vendor specific information. As an illustrative, non-limiting example, the body field may include the power information of the first device, the one or more thresholds of the first device, power supply information of the first device, or a combination thereof. The power supply information may include power supply size, charge rate of the power supply, duration of power when at full charge, or an indication whether the power supply is being charged, as illustrative, non-limiting examples.

The first device may transmit the beacon including the power indicator to one or more other devices of the NAN. In response to another device (such as a second device) of the NAN receiving the beacon (that includes the power indicator) from the first device, the second device determines whether to transmit a second beacon which may result in the second device assuming a role of master or non-master sync in the NAN.

Prior to transmission of the second beacon, the second device may determine power information associated with the second device. The power information associated with the second device may include a power level of a power supply of the second device, a power consumption rate associated with the power supply of the second device, an estimated duration of power remaining in the power supply of the second device, or a combination thereof, as illustrative, non-limiting examples. The second device may compare the power information (of the second device) to one or more thresholds and the second device may determine that the second device can assume the role of master (or non-master sync) if the power information (of the second device) satisfies the one or more thresholds. For example, the second device may determine that the second device can assume the role of master if the second device determines that it has sufficient available power to assume the role of master (or non-master sync) based on the comparison of the power information of the second device to the one or more thresholds. To illustrate, the second device may determine that the second device can assume the role of master if the power level of the power supply of the second device is greater than or equal to a fourth threshold, the power consumption rate of the second device is less than or equal to a fifth threshold, the estimated duration of the power remaining at the second device is greater than or equal to a third threshold, or a combination thereof.

Additionally, or alternatively, the second device may transmit the second beacon based on a comparison between the power information of the second device and the power information of the first device. To illustrate, the second device may determine to transmit the second beacon if the power level of the power supply of the second device is greater than or equal to the power level of the power supply of the first device, the power consumption rate of the second device is less than or equal to the power consumption rate of the first device, the estimated duration of the power remaining at the second device is greater than or equal the estimated duration of the power remaining at the first device, or a combination thereof.

In some implementations, in response to the second device of the NAN receiving the beacon (that includes the power indicator) from the first device, the second device modifies (such as increases) a value associated with a rank of the second device, as described further herein. In some implementations, the rank includes a master rank of the second device. The modified value of the second device may be higher than a value of a rank of the first device. The second device transmits a beacon, such as a discovery beacon or synchronization beacon, that indicates the modified value. At transmission of the beacon (that indicates the modified value) or after transmission of the beacon (that indicates the modified value), the second device may assume the role of master in the NAN. In some implementations, the value of the rank of the second device is based on multiple parameters, such as a master preference value, a random factor, an interface address (such as a media access control (MAC) address) of the second device, or a combination thereof. The master preference value is a number greater than or equal to zero, such as an integer in a range of 0-255. The random factor is a random integer greater than or equal to zero, such as a random integer in a range of 0-255. To modify the value of the rank of the second device, the second device may modify (such as increase) the master preference value, the random factor, the interface address, or a combination thereof. The second device may include the modified master preference value, the modified random factor, the modified interface address, or a combination thereof, in the second beacon, such as a discovery beacon or a synchronization beacon, transmitted by the second device.

By having the first device send a beacon that includes the power indicator, such as the vendor specific attribute, the first device may indicate to other devices in the NAN that the first device has a low power condition. Additionally, the power indicator may correspond to a request by the first device for another device to assume a role of master (or non-master sync) within the NAN. Based on the power indicator included in the beacon, the second device of the NAN may proactively attempt to assume the role of master. Accordingly, devices of the NAN may utilize the power indicator to coordinate role assignment within the NAN when a master device (or non-master sync device) has a low power condition. The use of the power indicator may avoid more complex and high overhead messaging to communicate the low power condition and may avoid a master device (or a non-master device) dropping out of the NAN because of loss of power. Additionally, by having the second device assume the role of master (or non-master sync), the first device may be relieved from having to transmit one or more beacons, thus enabling the first device to conserve power.

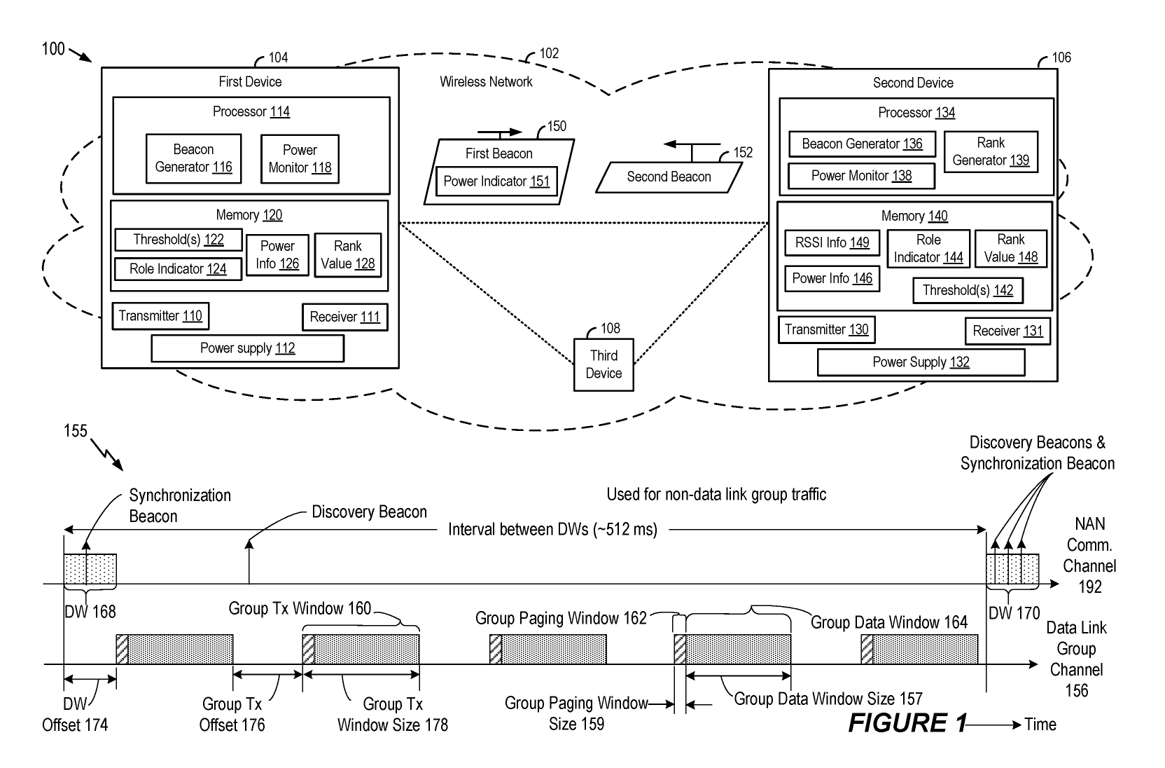

FIG. 1 shows an example of a system 100 that includes one or more devices of a network. The system 100 includes a wireless network 102, such as a NAN or wireless mesh network, that supports independent assessment of a channel condition (such as a channel quality) of a data link group by devices of the data link group.

The wireless network 102 may include one or more devices, such as a first device 104, a second device 106, and a third device 108. Each of the devices 104-108 may be a wireless communication device configured to transmit data and to receive data from one or more other wireless communication devices included in the wireless network 102. Each wireless device may include or correspond to a station, such as a wireless station or a wireless communication device. The wireless network 102 may be an infrastructure network or an infrastructure-less network, such as a peer-to-peer (P2P) network (such as an ad-hoc network). For example, each of the devices 104-108 of the wireless network 102 (the NAN) may be configured to perform association operations (such as security association operations), security information exchange operations, synchronization operations, negotiation operations, and other operations via one or more wireless channels corresponding to the NAN. In some implementations, the devices 104-108 may perform such operations in accordance with one or more standards, such as an Institute of Electrical and Electronics Engineers (IEEE) 802.11 standard (such as a IEEE 802.11s standard), a wireless-fidelity (Wi-Fi) Alliance standard, a NAN standard, or a combination thereof, as illustrative, non-limiting examples. Although the wireless network 102 is illustrated as including three devices, in other implementations the wireless network 102 may include more than three devices or fewer than three devices.

The wireless network 102 may include or correspond to one or more data link groups. As used herein, a data link group may include an infrastructure-less peer-to-peer network, such as an ad-hoc network. The data link group may include multiple devices that are able to form a network, such as a decentralized wireless network. Additionally, each device of the data link group may use common security credentials that may be exchanged using a channel of the data link group or another channel, such as a channel of a NAN. In some implementations, the devices of the data link group may be synchronized to have periodic wake-up times, such as time periods when each of the devices is awake to advertise and receive traffic and other messages (such as beacons, such as synchronization beacons).

In some implementations, the wireless network 102 may include or correspond to a data link group that includes one or more devices, such as the devices 104-108. The data link group also may be referred to as a data link, a data link network, a group network, a NAN data link (NDL), a NDL network, a data path group, a data path group network, a NAN data path, a NAN data path group, or a NAN data path group network. In some implementations, the data link group may be a mesh group included in a mesh network, such as a “social Wi-Fi mesh network” or an Institute of Electrical and Electronics Engineers (IEEE) 802.11s mesh network, as illustrative, non-limiting examples. As another example, the data link group may include an infrastructure-less peer-to-peer network.

As part of the data link group, the devices 104-108 may perform data exchanges via wireless communications that do not involve one or more wireless carriers, one or more Wi-Fi access points, the Internet, or a combination thereof, as illustrative, non-limiting examples. For example, the devices 104-108 of the data link group may share a security credential, such as a group key, to enable communication. To illustrate, each device of the data link group may use the group key to encode and decode group messages. In some implementations, one or more services, such as a music service, a social media sharing service, a file sharing service, a gaming service, a channel quality assessment service, or other services may be provided by one or more of the devices 104-108 of the data link group. In some implementations, the devices 104-108 of the data link group may be synchronized to have periodic wake-up times, such as time periods when each of the devices 104-108 is “awake” (such as in an active operating mode) to advertise a service, to receive traffic or other messages, or a combination thereof. In some implementations, the wireless network 102 may include multiple data link groups, and each data link group of the wireless network 102 may have a corresponding group identifier, such as a unique byte value, a group address, or a combination thereof. In implementations in which the wireless network 102 includes multiple data link groups, a particular device may be included in more than one data link group. Although FIG. 1 illustrates a data link group having three devices, in other implementations more than three devices or fewer than three devices may be included in a data link group.

An illustrative example of a timing diagram of messages that may be communicated in the data link group is depicted at 155. The timing diagram 155 illustrates a NAN communication channel 192 and a data link group channel 156. As an illustrative, non-limiting example, the NAN communication channel 192 includes channel number 6 for 2.4 gigahertz (GHz) radio and channel numbers 36 or 149 for 5G radio. The NAN communication channel 192 includes multiple discovery windows, such as a first discovery window (DW) 168 and a second discovery window 170. In some implementations, there may be a discovery window time interval of approximately 512 milliseconds (ms) between consecutive discovery windows. The data link group channel 156 includes multiple group transmission windows, such as a representative group transmission window 160. In some implementations, the group transmission windows occur with reference to the NAN communication channel 192. For example, when there is no data link group channel 156, the group transmission windows occur with reference to the NAN communication channel 192 and may be between the first discovery window 168 and the second discovery window 170.

In other implementations, the data link group channel 156 may include discovery windows (similar to the discovery windows 168, 170) and the group transmission windows occur between two discovery windows of the data link group channel 156. In some implementations, the discovery windows of the data link group channel 156 may be in addition to the first discovery window 168 and the second discovery window 170 of the NAN communication channel 192. In other implementations, there may be no NAN communication channel 192. In these implementations, the data link group channel 156 may have corresponding discovery windows.

In some implementations, the data link group may be included in a NAN and the devices of the data link group may communicate via the NAN communication channel 192. The devices of the NAN may be synchronized via one or more synchronization beacons that are communicated by a master device of the NAN, by a master device of a particular group of the NAN, or by a non-master sync device of the NAN. For example, one of the devices of the data link group may operate as the master device and may broadcast one or more synchronization beacons to other devices included in the NAN via the NAN communication channel 192.

Additionally, or alternatively, the devices included in the data link group may communicate via the data link group channel 156. The devices of the data link group may be synchronized via one or more synchronization beacons that are communicated by a master device of the data link group or a master device of a NAN that includes the data link group. For example, one of the devices of the data link group may operate as the master device and may broadcast one or more synchronization beacons to other devices of the data link group, other devices of the NAN, or a combination thereof, via the NAN communication channel 192, the data link group channel 156, or both.

Devices of a data link group may perform communication via the data link group channel 156 according to a transmission schedule. The transmission schedule may indicate a discovery window offset 174. The discovery window offset 174 may be a particular duration between an end of a discovery window (such as a first discovery window 168 of the wireless network 102) and a beginning of a subsequent group transmission window of the data link group channel 156. A group transmit (Tx) repeat value of the transmission schedule may indicate that multiple group transmission windows, such as the group Tx window 160, are repeated between consecutive discovery windows, such as the first discovery window 168 and the second discovery window 170.

A group Tx offset 176 of the transmission schedule may be a particular duration between consecutive group transmission windows. A group Tx window size 178 of the transmission schedule may correspond to a size (such as duration) of each group transmission window (such as each group Tx window 160). The group Tx window size 178 also may be referred to as a time-block size. Each group Tx window 160 may include a group paging window 162 and a group data window 164. A value of a group paging window size 159 of the transmission schedule may indicate a size (such as a duration) of the group paging window 162. A value of a group data window size 157 of the transmission schedule may indicate a size (such as a duration) of the group data window 164. In some implementations, the data link group may use multiple group channels and group Tx windows of the data link group may be divided among the multiple group channels. For example, a first time-block may occur at a first time on the data link group channel 156 between the discovery windows 168 and 170, and a second time-block may occur at a second time between the discovery windows 168 and 170 on a second group channel of the data link group after completion of the first time-block.

In some implementations, one or more frames (such as discovery frames or discovery beacons) or synchronization beacons may be broadcast via the NAN communication channel 192 of the wireless network 102. For example, a device may send a discovery frame during one or more discovery windows. To illustrate, the first device 104 may broadcast the discovery frame during the first discovery window 168, the second discovery window 170, or both. Additionally, or alternatively, a discovery frame (such as a discovery beacon) may be transmitted at one or more times between two consecutive discovery windows, such as between the discovery windows 168, 170. The discovery frame may be received and used by a device that is not included in the wireless network 102 to “discover” the wireless network 102 (or the data link group network). Additionally, the discovery frame may enable the device to join the wireless network 102 (or the data link group network). A synchronization beacon may be used by multiple devices of the wireless network 102 for time synchronization function (TSF) correction. For example, the synchronization beacon may include a timestamp that is used to update timers, such as a TSF clock, of devices of the wireless network 102.

During a discovery window, such as the first discovery window 168, each of the devices of the data link group may be awake and may monitor one or more channels, such as the NAN communication channel 192, for beacons, messages, or both. In some implementations, the beacons, the messages, or both, may indicate traffic to be sent during a subsequent data window. Beacons or messages sent during the discovery window may be secure (such as encoded or encrypted) or un-secure (such as un-encoded or unencrypted). A secure beacon or secure message transmitted during the discovery window may be encoded using a key, such as a group key of the data link group. If a particular device determines, based on beacon(s) or message(s) received during the discovery window, that the particular device will be receiving traffic data during the subsequent data window, the particular device may stay awake during the subsequent data window. Conversely, if a device does not receive such an indication, the device may “go to sleep” (such as enter a sleep mode or power-save mode) during the subsequent data window. Alternatively, if a device does not receive such an indication, the device may stay awake and perform an operation during the subsequent data window, such as monitoring traffic of a channel of the data link group or traffic of another channel.

During a paging window, each of the devices of the data link group may be awake and may monitor for beacons, messages, or both. In some implementations, the beacons, the messages, or both, may indicate traffic to be sent during a subsequent data window. Beacons or messages sent during the paging window may be secure (such as encoded or encrypted) or un-secure (such as un-encoded or unencrypted). It is noted that, in some implementations, un-secure messages may be received and deciphered by a device regardless of whether or not the device is included in the data link group. When a secure beacon or a secure message is transmitted during the paging window, the secure beacon or the secure message may be encoded using a key, such as a group key (for data link group addressed traffic) or a pairwise key (for peer-to-peer addressed traffic). It is noted that data link group addressed traffic can be broadcast to each device of the data link group or can be unicast to a single device of the data link group. If a particular device determines, based on beacon(s) or message(s) received during the paging window, that the particular device may receive traffic data during the subsequent data window, the particular device may stay awake during the subsequent data window. Alternatively, if the particular device does not receive an indication that it may receive data, the particular device may “go to sleep” (such as enters the sleep mode or the power-save mode) during the subsequent data window.

As shown in FIG. 1, the first device 104 includes a processor 114, a memory 120, a transmitter 110, a receiver 111, and a power supply 112. In some implementations, the processor 114, the memory 120, the transmitter 110, the receiver 111, the power supply 112, or a combination thereof, may be integrated into a mobile communication device.

The transmitter 110 is configured to transmit data, such as one or more beacons. For example, the transmitter 110 transmits a beacon a discovery beacon or a synchronization beacon. Additionally, or alternatively, the transmitter 110 is configured to transmit messages, represented by one or more data packets, to one or more devices. The receiver 111 is configured to receive data from one or more devices. For example, the receiver 111 receives one or more beacons from other devices of the wireless network 102. The power supply 112 may include a battery (such as a rechargeable battery) or another power source. Although the power supply 112 is described as being included in the first device 104, in other implementations, the power supply 112 may be external to the first device 104.

The processor 114 is configured to perform one or more operations corresponding to operation of the wireless network 102 (such as the NAN). The processor 114 includes a beacon generator 116 and a power monitor 118. The beacon generator 116 is configured to generate one or more beacons, as described further herein. For example, the one or more beacons may include a discovery beacon or a synchronization beacon.

The power monitor 118 is configured to monitor the power supply 112 and to determine power information 126 associated with the power supply 112. For example, the power monitor 118 is configured to perform operations to determine (such as calculate) an amount of available power at the first device 104, an estimated duration of remaining power at the first device 104, a power consumption rate of the first device 104, or a combination thereof. Additionally, or alternatively, the power monitor 118 is configured to perform operations to determine (such as calculate) power supply information of the first device 104, such as a power supply size, a charge rate of the power supply 112, an estimated amount of time to charge the power supply 112, whether the power supply 112 is being charged, or a combination thereof. In some implementations, the power supply information (of the first device 104) may be included in the power information 126.

The memory 140 is configured to store data, such as one or more thresholds 122, a role indicator 124, the power information 126, and a rank value 128. The role indicator 124 indicates an operational mode of the first device 104. For example, the role indicator 124 indicates whether the first device 104 is operating as a master device or a non-master device (such as a non-master sync or a non-master, non-sync). The rank value 128 is associated with a numerical indication for the first device to operate as a master device. In some implementations, the rank value 128 may be determined by the processor 114 based on a master preference value, a random factor, an interface address (such as a media access control (MAC) address) of the first device 104, or a combination thereof. The master preference value, the random factor, the interface address, or a combination thereof, may be stored in the memory 120. The master preference value is a number greater than or equal to zero, such as an integer in a range of 0-255. The random factor is a random integer greater than or equal to zero, such as a random integer in a range of 0-255. In some implementations, the processor 114 may determine a rank value of another device based on information received from the other device, such as a master preference value of the other device, a random factor of the other device, an interface address (such as a media access control (MAC) address) of the other device, or a combination thereof.

The second device 106 includes a processor 134, a memory 140, a transmitter 130, a receiver 131, and a power supply 132. In some implementations, the processor 134, the memory 140, the transmitter 130, the receiver 131, the power supply 132, or a combination thereof, may be integrated into a mobile communication device.

The transmitter 130 is configured to transmit data, such as one or more beacons. For example, the transmitter 130 is configured to transmit a discovery beacon or a synchronization beacon. Additionally, or alternatively, the transmitter 130 is configured to transmit messages, represented by one or more data packets, to one or more devices. The receiver 131 is configured to receive data from one or more devices. For example, the receiver 131 receives one or more beacons from other devices of the wireless network 102. The power supply 132 may include a battery or other power source. Although the power supply 132 is described as being included in the second device 106, in other implementations, the power supply 132 may be external to the second device 106.

The processor 134 is configured to perform one or more operations corresponding to operation of the wireless network 102. The processor 134 includes a beacon generator 136, a power monitor 138, and a rank generator 139. The beacon generator 136 is configured to generate one or more beacons, as described further herein. For example, the one or more beacons may include a discovery beacon or a synchronization beacon. The rank generator 139 is configured to determine a rank value 148 of the second device 106. In some implementations, the rank value 148 may be determined by the rank generator 139 based on a master preference value, a random factor, an interface address (such as a media access control (MAC) address) of the second device 106, or a combination thereof. The master preference value, the random factor, the interface address, or a combination thereof, may be stored in the memory 140.

The power monitor 138 is configured to monitor the power supply 132 and to determine power information 146 associated with the power supply 132. For example, the power monitor 138 is configured to perform operations to determine (such as calculate) an amount of available power at the second device 106, an estimated duration of remaining power at the second device 106, a power consumption rate of the second device 106, or a combination thereof. Additionally, or alternatively, the power monitor 138 is configured to perform operations to determine (such as calculate) power supply information of the second device 106, such as a power supply size, a charge rate of the power supply 132, an estimated amount of time to charge the power supply 132, whether the power supply 132 is being charged, or a combination thereof. In some implementations, the power supply information (of the second device 106) may be included in the power information 146.

The memory 140 is configured to store data, such as one or more thresholds 142, a role indicator 144, the power information 146, a rank value 148, and RSSI information 149. The RSSI information 149 indicates a received signal strength (such as an average received signal strength) associated with messages received from one or more devices of the wireless network 102. For example, the RSSI information 149 indicates a received signal strength associated with beacons received from the first device 104.

The role indicator 144 indicates an operational mode of the second device 106. For example, the role indicator 144 indicates whether the second device 106 is operating as a master device or a non-master device, such as a non-master sync device or a non-master, non-sync device. The rank value 148 is a numerical indication of the second device's ability to operate as a master device. In some implementations, the rank value 148 may be determined by the processor 134 based on the master preference value, the random factor, the interface address (such as a media access control (MAC) address) of the second device 106, or a combination thereof. In some implementations, the processor 134 may determine a rank value of another device based on information received from the other device, such as a master preference value of the other device, a random factor of the other device, an interface address of the other device, or a combination thereof.

The third device 108 may include one or more components as described with respect to the first device 104, the second device 106, or both. Accordingly, the third device 108 may include a processor, a memory, a transmitter, a receiver, and a power supply. The third device 108 may be configured to perform one or more operations as described with reference to operation of the first device 104, the second device 106, or both.

During operation, the first device 104 has a role of master (or non-master sync) in the wireless network 102 and each of the second device 106 and the third device 108 may have a role of non-master in the wireless network 102. For example, the role indicator 124 of the first device 104 may indicate that the first device 104 is operating in a master operating mode, and the role indicator 144 of the second device 106 may indicate that the second device 106 is operating in a non-master operating mode.

While the first device 104 has the master role (or the non-master sync role), the processor 114 (such as the power monitor 118) of the first device 104 may monitor the power information 126 associated with the power supply 112 of the first device 104. The power information 126 may include or correspond to an amount of available power at the first device 104, an estimated duration of remaining power at the first device 104, a power consumption rate of the first device 104, or a combination thereof.

The processor 114 (such as the power monitor 118) of the first device 104 may detect a low power condition associated with the power supply 112 of the first device 104. For example, the first device 104 may compare the power information 126 to the one or more thresholds 122, and the processor 114 (such as the power monitor 118) may detect the low power condition if the power information 126 satisfies the one or more thresholds 122. For example, the low power condition may be detected if the power level of the power supply 112 is less than or equal to a first threshold (of the one or more thresholds 122), the power consumption rate is greater than or equal to a second threshold (of the one or more thresholds 122), the estimated duration of the power remaining is less than or equal to a third threshold (of the one or more thresholds 122), or a combination thereof.

The processor 114 (such as the beacon generator 116) generates a first beacon 150, such as a discovery beacon or a synchronization beacon, that includes a power indicator 151 based on detection of the low power condition. In some implementations, the processor 114 initiates transmission of the first beacon during a particular time period, such as discovery window. The power indicator 151 may correspond to a request for another device of the wireless network 102 to assume a master role. The power indicator 151 may be associated with a vendor specific attribute (such as a vendor specific information element) that is included in the first beacon 150. The vendor specific attribute may comply with a standard, such as an IEEE 802.11 standard, a Wi-Fi Alliance standard, or both.

The vendor specific attribute may have a format that includes one or more fields, such as an attribute identifier field, a length field, a vendor specific organizationally unique identifier (OUI) field, and a body field. The power indicator 151 may be included in the attribute identifier field. Additionally, or alternatively, the power indicator 151 may be included in the body field. A value of the length field may indicate a length of the OUI field, the body field, or a combination thereof. A value of the vendor specific OUI field may be used to identify devices, such as the devices 104, manufactured by the same vendor, distributed by the same vendor, or operated according to software provided by the same vendor. The body field may include vendor specified information. As an illustrative, non-limiting example, the body field may include the power information 126 of the first device 104, the one or more thresholds 122 of the first device 104, power supply information (such as power supply size, charge rate of the power supply 112, duration of power when at full charge, whether the power supply 112 is being charged, etc.) of the first device 104, or a combination thereof. Additionally, or alternatively, the body field may indicate whether the first device 104 is being charged, a rate of charge, an amount of charge until a threshold power level is reached, or a combination thereof.

The processor 114 initiates transmission of the first beacon 150 via the transmitter 110. The first beacon 150 (including the power indicator 151) is transmitted from the first device 104 to one or more devices, such as the second device 106, the third device 108, or both, of the wireless network 102.

The second device 106 receives the first beacon 150. For example, the second device 106 is configured to receive the first beacon 150 via the receiver 131. The second device 106 is configured to process (such as decode) the first beacon 150 and detect (such as identify) the power indicator 151 included in the first beacon 150.

Based on detection of the power indicator 151, the processor 134 (such as the beacon generator 136) may generate a second beacon 152, such as a discovery beacon or a synchronization beacon. The processor 134 may initiate transmission of the second beacon 152 via the transmitter 130. If the second beacon 152 is a discovery beacon, the second device 106 transmits the second beacon 152 during a next discovery window. If the second beacon 152 is a synchronization beacon, the second device 106 transmits the second beacon 152 during a next discovery window or within a threshold amount of time from a previously received synchronization beacon. The second beacon 152 may be transmitted from the second device 106 to one or more devices, such as the first device 104, the third device 108, or both, of the wireless network 102.

In some implementations, based on detection of the power indicator 151, the processor 134 (such as the power monitor 138) may determine the power information 146 of the second device 106. The second device 106 may compare the power information 146 of the second device 106 to the one or more thresholds 142. If the power information 146 of the second device 106 fails to satisfy the one or more thresholds 142, the second device 106 determines that it does not have sufficient power to be a master device (or a non-master sync device) in the wireless network 102 and maintains its role in the NAN. Alternatively, if the power information 146 of the second device 106 satisfies the one or more thresholds 142, the second device 106 determines to attempt to assume the master role in the wireless network 102.

For example, the power information 146 may satisfy the one or more thresholds 142 if the power level of the power supply 132 of the second device 106 is greater than or equal to a fourth threshold (of the one or more thresholds 142), the power consumption rate of the second device 106 is less than or equal to a fifth threshold (of the one or more thresholds 142), the estimated duration of the power remaining at the second device 106 is greater than or equal to a third threshold (of the one or more thresholds 142), or a combination thereof. Additionally, or alternatively, the second device 106 may determine to attempt to assume the master role in the wireless network 102 based on a comparison between the power information 146 of the second device 106 and the power information 126 of the first device 104 (such as the power information 126 included in the first beacon 150). To illustrate, the second device 106 may determine to attempt to assume the master role if the power level of the power supply 132 of the second device 106 is greater than or equal to the power level of the power supply 112 of the first device 104, the power consumption rate of the second device 106 is less than or equal to the power consumption rate of the first device 104, the estimated duration of the power remaining at the second device 106 is greater than or equal the estimated duration of the power remaining at the first device 104, or a combination thereof.

In response to a determination to attempt to assume the master role (or the non-master sync role) in the wireless network 102, the processor 134 (such as the rank generator 139) may update the rank value 148. Updating the rank value 148 may include modifying (such as increasing) a master preference value of the second device 106, a random factor of the second device 106, an interface address (such as a media access control (MAC) address) of the second device 106, or a combination thereof. In some implementations, the second beacon 152 transmitted by the second device 106 includes an indication of the rank value 148. For example, the second beacon 152 transmitted by the second device 106 may include the modified master preference value of the second device 106, the modified random factor of the second device 106, the modified interface address of the second device 106, or a combination thereof.

In some implementations, responsive to determining that the power information 146 satisfies the one or more thresholds 142, the second device 106 may increase a transmit power of the transmitter 130. In some implementations, the transmit power of the transmitter 130 may be set based on a received signal strength (such as the received signal strength indicator (RSSI) information 149) associated with beacons received from the first device 104. For example, the transmit power of the transmitter 130 may be set to be greater than or equal to the received signal strength associated with one or more beacons received from the first device 104. The second beacon 152 may be transmitted by the transmitter 130 operating at the updated transmit power.

In some implementations, the first device 104 may receive the second beacon 152 and, responsive to the second beacon 152, the first device 104 may change the role indicator 124 of the first device 104 to indicate that the first device 104 is a non-master device (such as the first device 104 is operating according to a non-master operating mode, such as a non-master, non-sync operating mode). Additionally, or alternatively, after transmitting the second beacon 152, the second device 106 may update the role indicator 144 of second device 106 to indicate that the second device 106 is a master device (such as the second device 106 is operating according to a master device operating mode) or a non-master sync device (such as the second device 106 is operating according to a non-master sync device operating mode).

In some implementations, the third device 108 receives the first beacon 150. In response to first beacon 150, the third device 108 is configured to process the first beacon 150 and detect the power indicator 151 included in the first beacon 150. In response to detection of the power indicator 151, the third device 108 is configured to determine whether to attempt to assume the master role (or the non-master sync role). For example, the third device 108 determines power information of the third device 108 and determines whether the power information of the third device 108 satisfies one or more thresholds, as described above with reference to the second device 106.

In response to a determination to attempt to assume the master role (or the non-master sync role), the third device 108 may update (such as increase) a rank value of the third device 108. Updating the rank value of the third device 108 may include modifying (such as increasing) a master preference value of the third device 108, a random factor of the third device 108, an interface address (such as a media access control (MAC) address) of the third device 108, or a combination thereof.

In response to a determination to attempt to assume the master role (or the non-master sync role), the third device 108 transmits a third beacon (not shown). The third beacon transmitted from the third device 108 to one or more devices, such as the first device 104, the second device 106, or both, of the wireless network 102. In some implementations, the third beacon may include the power information of the third device 108, an indication of the rank of the third device 108, or both. For example, the third beacon may include the modified master preference value of the third device 108, the modified random factor of the third device 108, the modified interface address of the third device 108, or a combination thereof. Additionally, or alternatively, the third beacon may include power supply information associated with a power supply of the third device 108. The power supply information may include a power supply size, a charge rate of the power supply of the third device 108, an estimated amount of time to charge the power supply of the third device 108, whether the power supply of the third device 108 is being charged, or a combination thereof. In some implementations, the power supply information of the third device 108 may be included in the power information of the third device 108.

In some implementations, the second device 106 receives the third beacon from the third device 108. In response to receiving the third beacon, the second device 106 may determine whether to update the role indicator 144 of the second device 106 to indicate a master operating mode or a non-master sync operating mode. For example, the second device 106 may determine to update the role indicator 144 based on a comparison of the rank value 148 and a rank value of the third device 108. To illustrate, the second device 106 may determine a rank value of the third device 108 based on an indicator of the rank value of the third device 108 included in the third beacon. To illustrate, the second device 106 may determine the rank value of the third device 108 based on the modified master preference value of the third device 108, the modified random factor of the third device 108, the modified interface address of the third device 108, or a combination thereof, included in the third beacon. The second device 106 may compare the rank value of the third device 108 to the rank value 148 of the second device 106. If the rank value 148 of the second device 106 is greater than the rank value of the third device 108, the second device 106 updates the role indicator 144 to indicate a master role or a non-master sync role. Alternatively, if the rank value 148 of the second device 106 is less than the rank value of the third device 108, the second device 106 maintains the role indicator 144 (such as the second device 106 does not update the role indicator 144 from a current value).

As another example, the second device 106 determines whether to update the role indicator 144 of the second device 106 to indicate a master operating mode or a non-master sync operating mode based on a comparison of the power information 146 of the second device 106 to the power information of the third device 108. To illustrate, the second device 106 may update the role indicator 144 of the second device 106 to indicate a master operating mode or a non-master sync operating mode if the power level of the power supply 132 of the second device 106 is greater than or equal to the power level of the power supply of the third device 108, the power consumption rate of the second device 106 is less than or equal to the power consumption rate of the third device 108, the estimated duration of the power remaining at the second device 106 is greater than or equal the estimated duration of the power remaining at the third device 108, or a combination thereof.

As another example, the second device 106 determines whether to update the role indicator 144 of the second device 106 to indicate a master operating mode or a non-master sync operating mode based on a comparison of the power supply information of the second device 106 to the power supply information of the third device 108. To illustrate, the second device 106 may update the role indicator 144 of the second device 106 to indicate a master operating mode or a non-master sync operating mode if the power supply size of the power supply 132 of the second device 106 is greater than the power supply size of the power supply of the third device 108, the charge rate of the power supply 132 of the second device 106 is greater than the charge rate of the power supply of the third device 108, an estimated amount of time to charge (to a particular charge level) the power supply 132 of the second device 106 is less than the estimated amount of time to charge (to the particular charge level) the power supply of the third device 108, or a combination thereof. Additionally, or alternatively, the second device 106 may update the role indicator 144 of the second device 106 to indicate a master operating mode or a non-master sync operating mode if the power supply 132 of the second device 106 is being charged and the power supply of the third device 108 is not being charged.

It is noted that when the third device 108 transmits the third beacon and also receives the second beacon 152, the third device 108 determines whether to update the role indicator of the third device 108 to indicate a master operating mode or a non-master sync operating mode. For example, the third device 108 may perform similar operations, as described with reference to the second device 106, to determine whether to update a role indicator of the third device 108. The devices 104, 106, 108 each independently decides, based on information from other devices, whether to take on the master or non-master sync role.

Although certain operations and functions of the system 100 have been described with respect to a corresponding device, each of the devices 104-108 may be configured to perform one or more operations, functions, or a combination thereof, described with reference to another of the devices 104-108. For example, each of the devices 104-108 may include corresponding processor, a corresponding memory, a corresponding receiver, and a corresponding transmitter, as described with reference to the processor 114, the memory 120, the receiver 111, and the transmitter 110.

One advantage provided by at least one of the disclosed aspects is that the first device 104 may indicate to other devices in the wireless network 102 that the first device 104 has a low power condition. Additionally, the power indicator 151 may indicate, to other devices of the wireless network 102, a request by the first device 104 for another device to assume a role of master (or non-master sync) within the wireless network. Based on the power indicator 151 included in the beacon, the second device 106 may proactively attempt to assume the role of master. Accordingly, devices of wireless network may utilize the power indicator 151 to coordinate role assignment when a master device (or non-master sync device) has a low power condition. The use of the power indicator 151 may avoid use of more complex and high overhead messaging to communicate the low power condition and may avoid a master device (or a non-master device) dropping out of the wireless network because of loss of power. Additionally, by having the second device 106 assume the role of master (or non-master sync), the first device 104 may be relieved from having to transmit one or more beacons, thus enabling the first device 104 to conserve power.

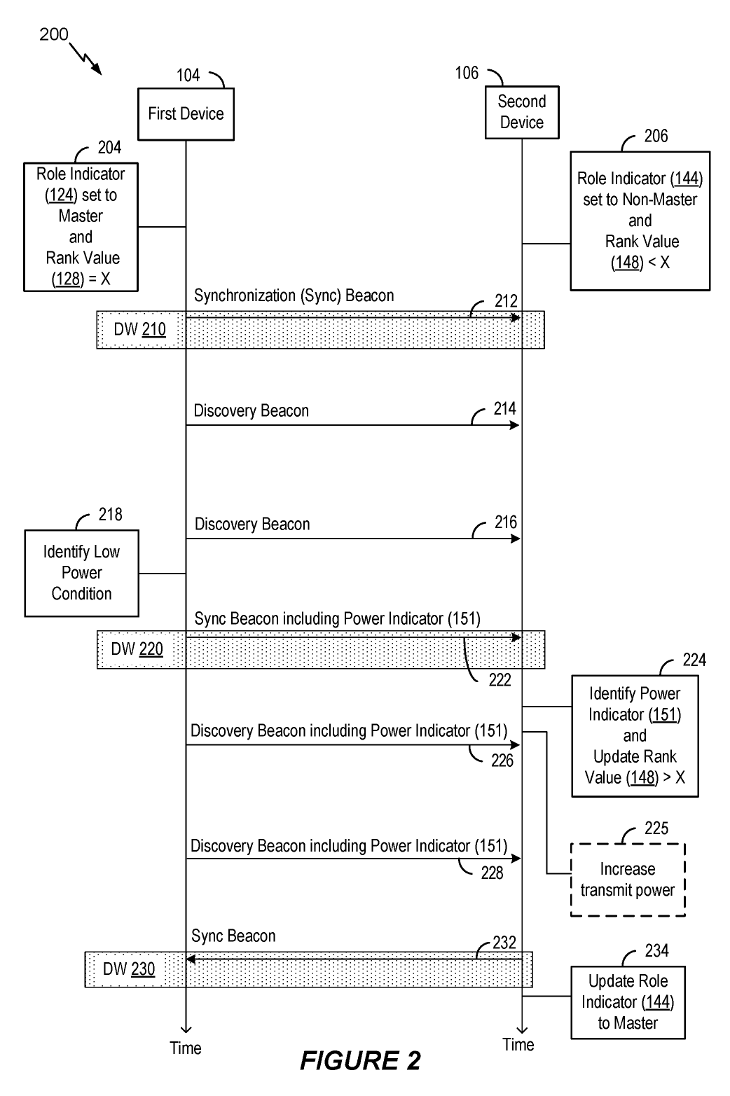

Referring to FIG. 2, a ladder diagram illustrating operation of the system 100 is depicted and generally designated 200. For example, the ladder diagram 200 depicts an example of using a power indicator for role assignment in a NAN, as described herein. The ladder diagram 200 includes the first device 104 and the second device 106. It should be noted that although FIG. 2 depicts two devices 104, 106, more than two devices may be present. Each of the devices 104, 106 may operate in compliance with a standard, such as an IEEE 802.11 standard, a Wi-Fi Alliance standard, or both.

During operation of the system 100, at a first time 204, the first device 104 sets the role indicator 124 of the first device 104 to indicate a master role (such as a master mode of operation) in the wireless network 102 (such as the NAN). Additionally, at the first time 204, the rank value 128 of the first device 104 is equal to X, where X is a positive number. At a second time 206, the second device 106 sets the role indicator 144 of the second device 106 to indicate a non-master role (such as a non-master mode of operation) in the wireless network 102. Additionally, at the second time 206, the rank value 148 of the second device 106 is less than X (such as the rank value 148 of the second device 106 is less than the rank value 128 of the first device 104).

The first device 104 transmits a synchronization (sync) beacon during a first discovery window 210 to the second device 106 at a third time 212. The first device 104 transmits a discovery beacon at a fourth time 214 and transmits another discovery beacon at a fifth time 216.

The first device 104 identifies a low power condition at the first device 104 at a sixth time 218. For example, the first device 104 may monitor the power information 126 associated with the power supply 112 of the first device 104. The power information 126 may include or correspond to an amount of available power at the first device 104, an estimated duration of remaining power at the first device 104, a power consumption rate of the first device 104, or a combination thereof. The first device 104 may detect the low power condition in response to the power information satisfying the one or more thresholds 122.

The first device 104 transmits, at a seventh time 222, a sync beacon that includes the power indicator 151 during a second discovery window 220. The sync beacon transmitted during the second discovery window 220 may include or correspond to the first beacon 150 of FIG. 1. The sync beacon including the power indicator 151 is received by the second device 106 and processed (such as decoded) by the second device 106.

At an eighth time 224, the second device 106 detects (such as identifies) the power indicator 151 included in the sync beacon transmitted during the second discovery window 220. Based on detection of the power indicator 151, the second device 106 updates the rank value 148 of the second device 106 to be greater than X.

To illustrate, in response to detection of the power indicator 151, the second device 106 may determine whether the second device 106 can assume a master role in the wireless network 102. To determine whether the second device 106 can assume the role of master in the wireless network 102, the second device 106 may compare the power information 146 of the second device 106 to the one or more thresholds 142. If the power information 146 of the second device 106 fails to satisfy the one or more thresholds 142, the second device 106 determines that it cannot assume the master role in the wireless network 102 (such as the second device 106 determines that it does not have sufficient power available to assume the master role in the wireless network 102). Alternatively, if the power information 146 of the second device 106 satisfies the one or more thresholds 142, the second device 106 determines that it can assume the master role in the wireless network 102 (such as the second device 106 determines that it has sufficient power available to assume the master role in the wireless network 102). In some implementations, the second device 106 updates the rank value 148 in response to determining the power information 146 satisfies the one or more thresholds 142. Updating the rank value 148 may include modifying (such as increasing) a master preference value, a random factor, an interface address (such as a media access control (MAC) address) of the second device, or a combination thereof.

Additionally, in a particular implementation, responsive to determining that the power information 146 satisfies the one or more thresholds 142, the second device 106 may optionally increase a transmit power of the second device 106 at a ninth time 225. For example, the second device 106 may increase the transmit power of the transmitter 130 of the second device 106. In some implementations, the transmit power of the second device 106 may be set based on a received signal strength, such as the received signal strength indicator (RSSI) information 149, associated with beacons received from the first device 104. For example, the transmit power may be set to be greater than or equal to the received signal strength associated with one or more beacons received from the first device 104.

The first device 104 transmits a discovery beacon including the power indicator 151 at a tenth time 226 and transmits another discovery beacon including the power indicator 151 at an eleventh time 228. The second device 106 transmits, at a twelfth time 232, a sync beacon during a third discovery window 230. The sync beacon transmitted during the third discovery window 230 may include or correspond to the second beacon 152 of FIG. 1. In some implementations, the sync beacon transmitted by the second device 106 during the third discovery window 230 includes an indication of the rank value 148. For example, the sync beacon transmitted by the second device 106 during the third discovery window 230 may include the modified master preference value, the modified random factor, the modified interface address, or a combination thereof. After transmission of the sync beacon during the third discovery window 230, the second device 106 may update, at a thirteenth time 234, the role indicator 144 of the second device 106 to indicate a master role in the wireless network 102. Although the second device 106 is described as waiting to transmit the sync beacon at the twelfth time 232, in other implantations, the second device 106 does not wait until the third discovery window 230 and transmits a discovery beacon (that indicates the updated rank value 148) after the eighth time 224.

By including the power indicator 151 (such as the vendor specific attribute) in a beacon, the first device 104 may indicate to the second device 106 that the first device 104 has a low power condition. Based on detection of the power indicator 151 by the second device 106, the second device 106 may proactively assume the role of master. Accordingly, devices of the wireless network 102 may utilize the power indicator 151 to coordinate role assignment within the NAN when a master device (or non-master sync device) has a low power condition.

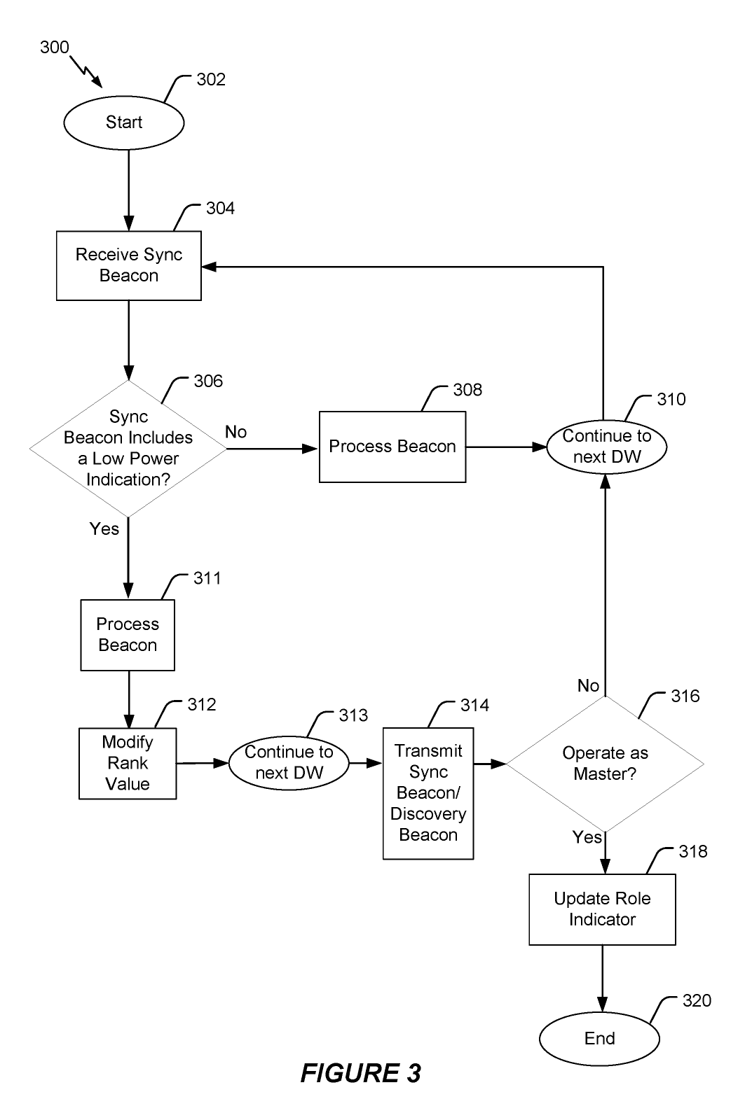

Referring to FIG. 3, a method 300 of operation at a device of a neighbor aware network (NAN) is shown. For example, the method 300 may be related to a method of wireless communication at the device. The NAN may include or correspond to the wireless network 102 of FIG. 1. The method 300 may be performed at any of the devices 104-108 of FIG. 1.

The method 300 may begin at 302. At 304, the method 300 includes receiving a sync beacon. For example, the sync beacon may be received during a discovery window associated with the wireless network 102 of FIG. 1. To illustrate, the sync beacon may be received by the second device 106 or the third device 108 of FIG. 1. The sync beacon may include or correspond to the first beacon 150 of FIG. 1, the sync beacon transmitted during the first discovery window 210, or the sync beacon transmitted during the second discovery window 220 of FIG. 2.

The method 300 includes determining whether the sync beacon includes a power indicator (such as a low power indication), at 306. For example, the power indicator may include or correspond to the power indicator 151 of FIG. 1. In some implementations, the power indicator corresponds to a vendor specific attribute (such as a vendor specific information element) included in the sync beacon. The vendor specific attribute may comply with a standard, such as an IEEE 802.11 standard, a Wi-Fi Alliance standard, or both.

If the sync beacon (received at 304) is determined (at 306) to not include the power indicator, the method 300 includes processing the sync beacon by the device at 308 and the method 300 continues to a next discovery window at 310 for the device to receive another sync beacon. In some implementations, after processing (such as decoding) the sync beacon at 308 and prior to receiving another sync beacon during a next discovery window, the device may enter a sleep mode (or other low-power mode).

Alternatively, if the sync beacon (received at 304) is determined (at 306) to include the power indicator, the method 300 includes processing (such as decoding) the sync beacon by the device at 311 and modifying a rank value at 312. For example, referring to FIG. 1, after detecting the power indicator 151 included in first beacon 150, the second device 106 may update the rank value 148 of the second device 106. Although described as receiving a sync beacon at 304, in other implementations, a discovery beacon may be received at 304 and a determination is made at 306 whether the discovery beacon includes a low power indication.

The method 300 continues to a next discovery window at 313, and the method 300 includes transmitting a sync beacon or a discovery beacon at 314. For example, the sync beacon or discovery beacon (transmitted at 314) may be transmitted during a particular discovery window. In some implementations, the sync beacon or the discovery beacon (transmitted at 314) includes an indication of the rank value (modified at 312). The sync beacon or the discovery beacon (transmitted at 314) may include or correspond to the second beacon 152 of FIG. 1 or the sync beacon transmitted during the third discovery window 230 of FIG. 2.

The method 300 includes determining whether to operate the device in a master role of the NAN at 316. For example, determining whether to operate the device in the master role may be based on whether the device received any sync beacons during the particular discovery window. If the device did not receive any sync beacons during the particular discovery window, the device may determine to operate the device in the master role. If the device receives one or more sync beacons during the particular window, the device may determine (such as identify) a corresponding rank value for each of the received one or more sync beacons and may determine to operate the device in the master role if the rank value (modified at 312) of the device is a highest rank value as compared to the rank values determined for the received one or more sync beacons.

If a determination is made (at 316) to not operate the device in a role of master, the method 300 continues to a next discovery window at 310 for the device to receive another sync beacon. Alternatively, if a determination is made (at 316) to operate the device in the role of master, the method 300 advances to 318 and includes updating a role indicator of the device. The role indicator may include or correspond to the role indicator 144 of FIG. 1. The role indicator may be updated to indicate that the device is operating a master device of the NAN. The method 300 ends at 320.

By having the first device send a beacon that includes the power indicator (such as the vendor specific attribute), the first device may indicate to other devices in the NAN that the first device has a low power condition. Additionally, the power indicator may indicate to other devices of the NAN as a request by the first device for another device to assume a role of master (or non-master sync) within the NAN. Based on the power indicator included in the beacon, the second device of the NAN may proactively assume the role of master. Accordingly, devices of the NAN may utilize the power indicator to coordinate role assignment within the NAN when a master device (or non-master sync device) has a low power condition. The use of the power indicator may avoid more complex and high overhead messaging to communicate the low power condition and may avoid a master device (or a non-master device) dropping out of the NAN because of loss of power. Additionally, by having the second device assume the role of master (or non-master sync), the first device may be relieved from having to transmit one or more beacons, thus enabling the first device to conserve power.

By detecting the power indicator (such as the power indicator 151) included in the beacon, a particular device of the NAN may assume the role of master (or the role of non-master sync). Accordingly, devices of the NAN may utilize the power indicator to coordinate role assignment within the NAN when a master device (or non-master sync device) has a low power condition.

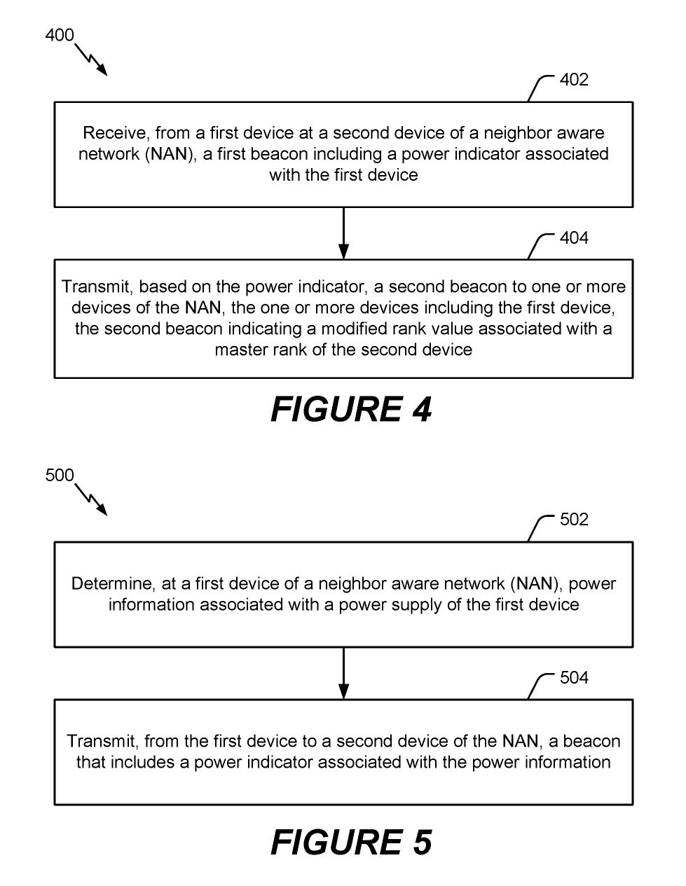

Referring to FIG. 4, a method 400 of operation at a device of a neighbor aware network (NAN) is shown. For example, the method 400 may be related to a method of wireless communication at the device. The NAN may include or correspond to the wireless network 102 of FIG. 1. The method 400 may be performed at any of the devices 104-108 of FIG. 1.

The method 400 includes receiving, from a first device at a second device of a neighbor aware network (NAN), a first beacon including a power indicator associated with the first device, at 402. During transmission of the first beacon, the first device may have a master role in the NAN and the second device may have a non-master role in the NAN. The power indicator may be associated with a low power condition and may correspond to a request for another device of the NAN to assume a master role of the NAN. Referring to FIG. 1, the second device 106 may receive the first beacon 150 from the first device 104. The power indicator, such as the power indicator 151 of FIG. 1, includes an attribute identifier of a vendor specific attribute. Additionally, in some implementations, the first beacon further includes a vendor identifier included in a vendor identifier portion of the vendor specific attribute. Each of the first device and the second device is associated with the vendor identifier. In some implementations, the first beacon further includes power information corresponding to the first device. For example, the power information indicates an amount of available power at the first device, an estimated duration of remaining power at the first device, a power consumption rate of the first device, or a combination thereof. The power information may be included in a body portion of the vendor specific attribute.

The method 400 includes transmitting, based on the power indicator, a second beacon to one or more devices of the NAN, at 404. The one or more devices include the first device. The second beacon includes a modified rank value associated with a master rank of the second device. For example, referring to FIG. 1, the second device 106 may transmit the second beacon 152 to the first device 104. The second beacon 152 may include the rank value 148 (after modification). In some implementations, the second beacon further includes a second power indicator that is associated with power information of the second device.

In some implementations, the method 400 includes modifying a rank value of the second device based on the power indicator. The modified rank value of the second device is higher than a rank value of the first device. For example, referring to FIG. 1, the second device 106 may modify the rank value 148 of the second device 106. In some implementations, the rank value includes a master rank value of the second device. The second device may determine the rank value based on multiple parameters, such as a master preference value, a random factor, an interface address of the second device, or a combination thereof. The master preference value is a number greater than or equal to zero, such as an integer in a range of 0-255. The random factor is a random integer greater than or equal to zero, such as a random integer in a range of 0-255. To modify the rank value of the second device, the second device may modify (such as increase) the master preference value, the random factor, the interface address, or a combination thereof. The second device includes an indication of the modified rank value in a beacon, such as a discovery beacon or a synchronization beacon, transmitted by the second device.

In some implementations, the method 400 further includes identifying the power indicator included in the first beacon. For example, the second device 106 may process the first beacon 150 and identify the power indicator 151 included in the first beacon 150. The method 400 also may include, in response to identifying the power indicator included in the first beacon, determining whether to transmit the second beacon. To illustrate, the method 400 may further include, in response to identifying the power indicator included in the first beacon, determining, at the second device, power information associated with a power supply of the second device and comparing the power information to a threshold. For example, referring to FIG. 1, the second device 106 may determine the power information 146 associated with the power supply and may compare the power information to the one or more thresholds 142. The method 400 may include, in response to determining that the power information satisfies the threshold, modifying the rank value of the second device. In some implementations, the method 400 further includes, in response in response to determining that the power information satisfies the threshold, adjusting a transmit power of the second device based on a received signal strength associated with one or more beacons received from the first device. For example, the transmit power may be adjusted to be greater than or equal to a received signal strength associated with one or more beacons received from the first device. The received signal strength may include or correspond to the RSSI information 149 of FIG. 1.

The method 400 of FIG. 4 enables one or more devices of the NAN to coordinate role assignment within the NAN when a master device (or non-master sync device) has a low power condition. Based on the power indicator included in the beacon, the second device of the NAN may proactively assume the role of master when the first device represents (using the power indicator) that it has a low power condition. The use of the power indicator may avoid more complex and high overhead messaging to communicate the low power condition and may avoid a master device (or a non-master device) dropping out of the NAN because of loss of power.

Referring to FIG. 5, a method 500 of operation at a device of a neighbor aware network (NAN) is shown. For example, the method 500 may be related to a method of wireless communication at the device. The method 500 may be performed at any of the devices 104-108 of FIG. 1.

The method 500 includes determining, at a first device of a neighbor aware network (NAN), power information associated with a power supply of the first device, at 502. For example, referring to FIG. 1, the first device 104 may determine the power information 126 associated with the power supply 112 of the first device 104. The NAN may include or correspond to the wireless network 102 of FIG. 1.

The method 500 includes transmitting, from the first device to a second device of the NAN, a beacon that includes a power indicator associated with the power information, at 504. For example, referring to FIG. 1, the first device 104 may transmit the first beacon 150 that includes the power indicator 151 associated with the power information 126. In some implementations, the first device has a master role in the NAN and the second device has a non-master role in the NAN. The power indicator may be associated with a low power condition and may correspond to a request for another device of the NAN to assume a master role of the NAN.

In some implementations, the method 500 may include receiving, from the second device after transmitting the beacon, a second beacon that indicates a rank value of the second device. For example, referring to FIG. 1, the first device 104 may receive the second beacon 152 (from the second device 106) that indicates the rank value 148 of the second device 106. The method 500 may further include, based on the rank value of the second device, modifying a role indicator of the first device to correspond to a non-master role. For example, referring to FIG. 1, the first device 104 may modify the role indicator 124 of the first device 104 to correspond to a non-master role of the wireless network 102.

In some implementations, to identify a low power condition at the first device, the method 500 may include comparing the power information to a threshold. For example, referring to FIG. 1, the power information 126 may be compared to the one or more thresholds 122. In response to determining that the power information satisfies the threshold, the method 500 may include generating the beacon that includes the power indicator, such as the first beacon 150 that includes the power indicator 151 of FIG. 1.

The method 500 of FIG. 5 enables one or more devices of the NAN to coordinate role assignment within the NAN when a master device (or non-master sync device) has a low power condition. The use of the power indicator may avoid more complex and high overhead messaging to communicate the low power condition and may avoid a master device (or a non-master device) dropping out of the NAN because of loss of power. Based on the power indicator included in the beacon, the second device of the NAN may proactively assume the role of master when the first device represents (using the power indicator) that it has a low power condition. By having the second device assume the role of master (or non-master sync), the first device may be relieved from having to transmit one or more beacons, thus enabling the first device to conserve power.

The process shown in the ladder diagram 200 of FIG. 2, the method 300 of FIG. 3, the method 400 of FIG. 4, the method 500 of FIG. 5, or a combination thereof, may be controlled by a processing unit such as a central processing unit (CPU), a controller, a field-programmable gate array (FPGA) device, an application-specific integrated circuit (ASIC), another hardware device, firmware device, or any combination thereof. As an example, the ladder diagram 200 of FIG. 2, the method 300 of FIG. 3, the method 400 of FIG. 4, the method 500 of FIG. 5, or a combination thereof, can be performed by one or more processors that execute instructions to generate or process a beacon that includes a power indicator as described herein. Additionally, a first portion of one of the ladder diagram 200 of FIG. 2 or the methods of FIGS. 3-5 may be combined with at least a second portion of another one of the ladder diagram 200 of FIG. 2 or the methods of FIGS. 3-5. For example, a first portion of the method 500 of FIG. 5 may be combined with a second portion of the method 400 of FIG. 4.

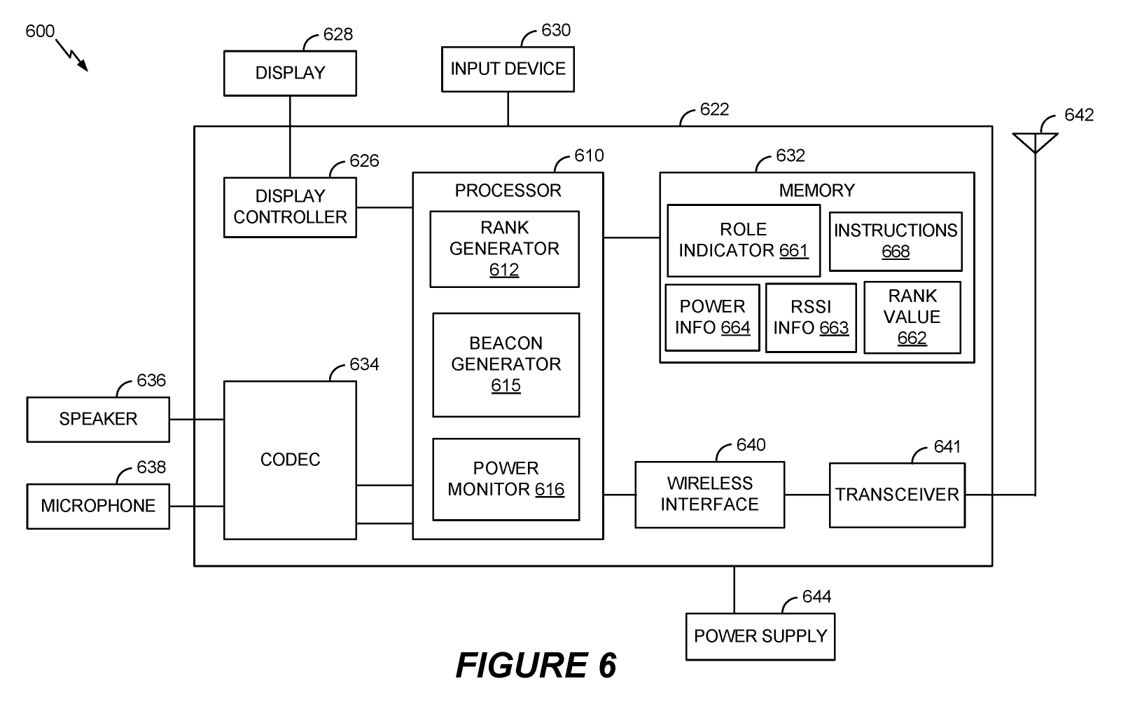

Referring to FIG. 6, a particular illustrative implementation of a wireless communication device is depicted and generally designated 600. The device 600, or components thereof, may correspond to the devices 104-108 of FIG. 1, or components thereof. The device 600 includes a processor 610, such as a digital signal processor, coupled to a memory 632.

Memory 632, such as a non-transitory computer readable medium, may include a role indicator 661, a rank value 662, RSSI information 663, power information 664, and instructions 668. The instructions 668 may be executable by the processor 610. For example, the memory 632 may include or correspond to the memory 120 or the memory 140 of FIG. 1. The role indicator 661 may include or correspond to the role indicator 124 or the role indicator 144 of FIG. 1. The rank value 662 may include or correspond to the rank value 128 or the rank value 148 of FIG. 1. The RSSI information 663 may include or correspond to the RSSI information 149 of FIG. 1. The power information 664 may include or correspond to the power information 126 or the power information 146 of FIG. 1.

The processor 610 includes a rank generator 612, a beacon generator 615, and a power monitor 616. The rank generator 612 may include or correspond to the rank generator 139 of FIG. 1. The beacon generator 615 may include or correspond to the beacon generator 116 or the beacon generator 136 of FIG. 1. The power monitor 616 may include or correspond to the power monitor 118 or the power monitor 138 of FIG. 1. The processor 610 may include or correspond to the processor 114 or the processor 134 of FIG. 1.

The processor 610 may be configured to execute software (such as a program represented by one or more of the instructions 668) stored in the memory 632. For example, the processor 610 may be configured to operate in accordance with the ladder diagram 200 of FIG. 2, the method 300 of FIG. 3, the method 400 of FIG. 4, the method 500 of FIG. 5, or a combination thereof. To illustrate, the processor 610 may be configured to execute the instructions 668 that cause the processor 610 to generate a second beacon based on a power indicator included in a first beacon received from a device of a neighbor aware network (NAN), such as the wireless network 102. The power indicator may be associated with first device of the NAN. For example, the power indicator may be associated with a low power condition at the device. The instructions 668 may further cause the processor 610 to initiate transmission of the second beacon to the device of the NAN. In some implementations, the second beacon may include an indication of the rank value 662.

As another example, the processor 610 may be configured to execute the instructions 668 that cause the processor 610 to determine, at the device 600 of the NAN, the power information 664 associated with a power supply 644 (such as a power source) of the device 600. The instructions 668 may further cause the processor 610 to initiate transmission, from the device 600 to another device of the NAN, a beacon that includes a power indicator associated with the power information 664.

FIG. 6 also shows a display controller 626 that is coupled to the processor 610 and to a display 628. A coder/decoder (CODEC) 634 also can be coupled to the processor 610. A speaker 636 and a microphone 638 can be coupled to the CODEC 634. FIG. 6 also indicates that a wireless interface 640 can be coupled to the processor 610 and to an antenna 642. For example, the wireless interface 640 may be coupled to the antenna 642 via a transceiver 641. The transceiver 641 may include a transmitter (such as the transmitter 110 or the transmitter 130), a receiver (such as the receiver 111 or the receiver 131), or both. The transceiver 641 may be configured to transmit one or more beacons generated by the beacon generator 615 and to receive one or more beacons transmitted to the device 600 by other devices, such as devices of the NAN.

In some implementations, the processor 610, the display controller 626, the memory 632, the CODEC 634, the wireless interface 640, and the transceiver 641 are included in a system-in-package or system-on-chip device 622. In some implementations, an input device 630 and the power supply 644 are coupled to the system-on-chip device 622. Moreover, in another particular implementation, as illustrated in FIG. 6, the display 628, the input device 630, the speaker 636, the microphone 638, the antenna 642, and the power supply 644 are external to the system-on-chip device 622. However, each of the display 628, the input device 630, the speaker 636, the microphone 638, the antenna 642, and the power supply 644 can be coupled to a component of the system-on-chip device 622, such as an interface or a controller.

In conjunction with one or more of the described implementations of FIGS. 1-6, a first apparatus includes means for receiving, from a device of a neighbor aware network (NAN), a first beacon including a power indicator associated with the device. For example, the means for receiving may include or correspond to the receiver 111, the receiver 131, the processor 114, the processor 134 of FIG. 1, the wireless interface 640, the transceiver 641, the antenna 642, the processor 610 programmed to execute the instructions 668 of FIG. 6, one or more other structures, devices, circuits, modules, or instructions to receive the first beacon, or any combination thereof.

The first apparatus also includes means for transmitting, based on the power indicator, a second beacon that indicates the modified rank value to the device. For example, the means for transmitting may include or correspond to the transmitter 110, the transmitter 130, the processor 114, the processor 134 of FIG. 1, the wireless interface 640, the transceiver 641, the antenna 642, the processor 610 programmed to execute the instructions 668 of FIG. 6, one or more other structures, devices, circuits, modules, or instructions to transmit the second beacon, or any combination thereof. In some implementations, the means for receiving and the means for transmitting are incorporated into a mobile communication device.

In some implementations, the first apparatus may include means for modifying a rank value. The rank value may be modified based on the power indicator. For example, the means for modifying may include or correspond to the processor 114, the processor 134 of FIG. 1, the processor 610 programmed to execute the instructions 668 of FIG. 6, one or more other structures, devices, circuits, modules, or instructions to modify the rank value, or any combination thereof.

In conjunction with the one or more described implementations, a second apparatus includes means for determining power information associated with a power supply. For example, the means for determining may include or correspond to the processor 114, the processor 134 of FIG. 1, the processor 610 programmed to execute the instructions 668 of FIG. 6, one or more other structures, devices, circuits, modules, or instructions to determine the power information, or any combination thereof.

The second apparatus includes means for transmitting, to a device of the NAN, a beacon that includes a power indicator associated with the power information. For example, the means for transmitting may include or correspond to the transmitter 110, the transmitter 130, the processor 114, the processor 134 of FIG. 1, the wireless interface 640, the transceiver 641, the antenna 642, the processor 610 programmed to execute the instructions 668 of FIG. 6, one or more other structures, devices, circuits, modules, or instructions to transmit the beacon, or any combination thereof. In some implementations, the means for determining and the means for transmitting are incorporated into a mobile communication device.

One or more of the disclosed implementations may be implemented in a system, a device, or an apparatus, such as the device 600, that may include a communications device, a fixed location data unit, a mobile location data unit, a mobile phone, a cellular phone, a satellite phone, a computer, a tablet, a portable computer, a display device, a media player, or a desktop computer. Alternatively or additionally, the device 600 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a satellite, a vehicle or a device integrated within a vehicle, any other device that includes a processor or that stores or retrieves data or computer instructions, or a combination thereof. As another illustrative, non-limiting example, the system, the device, or the apparatus may include remote units, such as hand-held personal communication systems (PCS) units, portable data units such as global positioning system (GPS) enabled devices, meter reading equipment, or any other device that includes a processor or that stores or retrieves data or computer instructions, or any combination thereof.

Although one or more of FIGS. 1-6 may illustrate systems, apparatuses, methods, or a combination thereof, according to the teachings of the disclosure, the disclosure is not limited to these illustrated systems, apparatuses, methods, or a combination thereof. One or more functions or components of any of FIGS. 1-6 as illustrated or described herein may be combined with one or more other portions of another function or component of FIGS. 1-6. Accordingly, no single implementation described herein should be construed as limiting and implementations of the disclosure may be suitably combined without departing from the teachings of the disclosure.

Those of skill in the art would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be included directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (such as non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A method for wireless communication, comprising:
receiving, from a first device at a second device of a neighbor aware network (NAN), a first beacon including a power indicator associated with the first device; and
based on the power indicator, transmitting a second beacon from the second device to one or more devices of the NAN, the one or more devices including the first device, the second beacon indicating a modified rank value associated with a master rank of the second device.

2. The method of claim 1, wherein the modified rank value indicates a role transition of the second device.

3. The method of claim 1, wherein the first beacon includes a synchronization beacon or a discovery beacon, and wherein, during transmission of the first beacon, the first device has a master role in the NAN and the second device has a non-master role in the NAN.

4. The method of claim 1, wherein the power indicator includes an attribute identifier of a vendor specific attribute (VSA).

5. The method of claim 4, wherein the first beacon further includes a vendor identifier included in a vendor identifier portion of the VSA, and wherein each of the first device and the second device is associated with the vendor identifier.

6. The method of claim 1, wherein the first beacon further includes power information corresponding to the first device.

7. The method of claim 6, wherein the power information is included in a body portion of a vendor specific attribute.

8. The method of claim 6, wherein the power information indicates an amount of available power at the first device, an estimated duration of remaining power at the first device, a power consumption rate of the first device, or a combination thereof.

9. The method of claim 1, further comprising:
identifying the power indicator included in the first beacon; and
in response to identifying the power indicator included in the first beacon, determining whether to transmit the second beacon.

10. The method of claim 1, further comprising:
identifying the power indicator included in the first beacon; and
in response to identifying the power indicator included in the first beacon:
determining, at the second device, power information associated with a power supply of the second device; and
comparing the power information to a threshold.

11. The method of claim 10, further comprising, in response to determining that the power information satisfies the threshold, modifying the rank value of the second device.

12. The method of claim 11, further comprising, in response to determining that the power information satisfies the threshold, modifying a master preference value of the second device, a random factor of the second device, an interface address of the second device, or a combination thereof, and wherein the second beacon includes the modified master preference value, the modified random factor, the modified interface address, or a combination thereof.

13. The method of claim 10, further comprising, in response to determining that the power information satisfies the threshold, adjusting a transmit power of the second device.

14. The method of claim 13, wherein the transmit power is adjusted to be greater than or equal to a received signal strength associated with one or more beacons received from the first device.

15. The method of claim 1, further comprising:
determining, at the second device, power information associated with a power supply of the second device; and
transmitting, from the second device to a third device, a third beacon that includes a second power indicator associated with the power information.

16. The method of claim 15, wherein, during transmission of the third beacon, the second device has a master role in the NAN and the third device has a non-master role in the NAN.

17. The method of claim 15, further comprising:
comparing the power information to a threshold; and
in response to determining that the power information satisfies the threshold, generating the third beacon that includes the second power indicator.

18. The method of claim 15, further comprising:
receiving, from the third device after transmitting the third beacon, a fourth beacon that indicates a rank value of the third device; and
based on the rank value of the third device, modifying a role indicator of the second device to correspond to a non-master role.

19. An apparatus comprising:
a receiver configured to receive a first beacon that includes a power indicator from a first device of a neighbor aware network (NAN) at a second device of the NAN; and
a transmitter configured to transmit a second beacon based on the power indicator to one or more devices of the NAN, the one or more devices including the first device, the second beacon indicating a modified rank value associated with a master rank of the second device.

20. The apparatus of claim 19, wherein the power indicator includes a vendor specific information element.

21. The apparatus of claim 19, wherein the first beacon includes a discovery beacon or a synchronization beacon.

22. The apparatus of claim 19, wherein the receiver and the transmitter are integrated into a mobile communication device.

23. The apparatus of claim 19, further comprising a processor configured to determine power information associated with a power supply, wherein the transmitter is configured to transmit a third beacon that includes a second power indicator associated with the power information to at least one device of the NAN.

24. The apparatus of claim 23, wherein the second power indicator is associated with a low power condition and corresponds to a request for another device of the NAN to assume a master role of the NAN.

25. The apparatus of claim 23, wherein the third beacon further includes the power information, and wherein a format of the second power indicator and the power information is based on a vendor specific attribute (VSA).

26. The apparatus of claim 23, further comprising a battery, wherein the processor is further configured to determine the power information associated with the battery, the power information comprising a power level of the battery, a power consumption rate associated with the battery, an estimated duration of power remaining in the battery, or a combination thereof.

27. An apparatus comprising:
means for receiving, from a device of a neighbor aware network (NAN), a first beacon including a power indicator associated with the device; and
means for transmitting, based the power indicator, a second beacon to one or more devices of the NAN, the one or more devices including the device, the second beacon indicating a modified rank value to the device.

28. The apparatus of claim 27, wherein the means for receiving and the means for transmitting are incorporated into a mobile communication device.

29. A non-transitory computer readable medium comprising instructions that, when executed by a processor, cause the processor to:
generate a second beacon at a second device based on a power indicator included in a first beacon received from a first device of a neighbor aware network (NAN), the power indicator associated with the first device, the second beacon indicating a modified rank value associated with a master rank of the second device; and
initiate transmission of the second beacon to one or more devices of the NAN, the one or more devices including the first device.

30. The non-transitory computer readable medium of claim 29, wherein the instructions, when executed by the processor, further cause the processor to modify the rank value of the second device based on the first beacon.
